(19) United States
(12) Patent Application Publication
(10) Pub. No.: US 2011/0240678 A1
(43) Pub. Date: Oct. 6, 2011

(54) Liquid or gel dispensing system

(76) Inventors: Anna I. Keller, Eagan, MN (US); Shelbie A. Foster, Eagan, MN (US)

(21) Appl. No.: 12/798,517

(22) Filed: Apr. 6, 2010

(51) Int. Cl. B65D 88/54; B67D 7/78

(52) U.S. Cl. 222/321.5; 222/464.7

(57) ABSTRACT

A dispenser for flowable materials has a storage area has a top and a bottom and sides defining a volume within the dispenser. The top of the dispenser has a manually useable pump attached thereto. The pump has an access tube extending from the pump into the volume within the dispenser, the access tube passing from the top towards the bottom of the dispenser within the volume. The bottom of the dispenser comprising two parts:
a first part comprising a surface within the volume capable of supporting the flowable materials within the volume and having a hole therein through which flowable material may flow; and
the second part of the bottom of the dispenser comprising a cap that is detachably connected to the first part and prevents flowable material through the hole when attached and allows flowable material to flow through the hole when unattached.

### BACKGROUND OF THE INVENTION

1. Field of the Invention

The present invention relates to the field of dispensing personal care or cosmetic or home use liquid or gel compositions from dispensers, especially polymeric dispensers with pump delivery systems on the dispenser.

2. Background of the Art

The cosmetic, personal care, home supplies and cleaning supply fields are each multi-billion dollar-a-year markets. The materials in each of these fields are provided in many different formats and containers. Large volumes may be provided in drums and transferred to individual delivery systems or pumped directly out of the drum. More commonly, these products are sold in individual user or individual household volumes and appropriate containers. When these products are flowable, as with liquids and gels, these containers may be twist open bottles or jars, snap open caps, twist open dispensing caps pumps and the like. There are may different variations in designs and shapes and formats for providing the flowable materials out of the container.

For many cleaning and personal care products, a popular method of liquid or gel delivery is the finger pump. On the top of the container is a pump system (with or without locking mechanisms) having a pump handle that is pressed with a digit and depressed, forcing liquid up through a tube inserted into the liquid or gel, and the material is delivered by pneumatic pressure out of a nozzle or outlet adjacent the pump handle.

There is one persistent problem in the minds of many consumers with the use of pump delivery systems. Even when the pump is no longer able to delivery flowable material from the container, significant amounts of material remains in the container. Users are forced to tilt the container to have material flow to the access tube for the pump, or add additional liquid (such as water) into the container to build up accessible volume, while diluting the material. This can be time consuming (removal of the pump, adding liquid, and repositioning the pump and access tube in the container, and cleaning up any residual mess or spillage) and the addition of liquids may impact the quality of the original material.

The present technology provides a container and dispenser that facilitates removal of residual flowable material from the container with minimal additional effort by the user.

### SUMMARY OF THE INVENTION

A dispenser for flowable materials has a storage area has a top and a bottom and sides defining a volume within the dispenser. The top of the dispenser has a manually useable pump attached thereto. The pump has an access tube extending from the pump into the volume within the dispenser, the access tube passing from the top towards the bottom of the dispenser within the volume. The bottom of the dispenser comprising two parts:
a first part comprising a surface within the volume capable of supporting the flowable materials within the volume and having a hole therein through which flowable material may flow; and
the second part of the bottom of the dispenser comprising a cap that is detachably connected to the first part and prevents flowable material through the hole when attached and allows flowable material to flow through the hole when unattached.

### BRIEF DESCRIPTION OF THE FIGURES

FIG. 1 shows a side view of a dispenser according to the present technology.

### DETAILED DESCRIPTION OF THE INVENTION

A dispenser for flowable materials has a storage area has a top and a bottom and sides defining a volume within the dispenser. The top of the dispenser has a manually useable pump attached thereto. The pump has an access tube extending from the pump into the volume within the dispenser, the access tube passing from the top towards the bottom of the dispenser within the volume. The bottom of the dispenser comprising two parts:
a first part comprising a surface within the volume capable of supporting the flowable materials within the volume and having a hole therein through which flowable material may flow; and
the second part of the bottom of the dispenser comprising a cap that is detachably connected to the first part and prevents flowable material through the hole when attached and allows flowable material to flow through the hole when unattached.

The second part may comprise a hinged lid that swings to open and close the hole and remains attached to the dispenser while the hole is opened by the second part being unattached to the hole. The hinged lid may comprise a living hinge (e.g., a continuous flexible element connecting the first part and the second part) that has a snap attachment removeably connecting the second part to the first part. A mechanical hinge of the same or different composition of the first and second part may also be used. The snap attachment may directly engage a spout from the hole, for example using a male attachment on the spout to snap into a female attachment on the second part. The surface of the first part may slope towards the hole within the volume to assist in causing flowable material to pool near the entrance to the hole. In a preferred embodiment, the sides of the volume defining portion of the dispenser comprise a flexible polymeric material such that when the sides are compressed, pressure is applied to flowable material to force flowable material out of the hole when the second part is unattached to the hole. Flexible or elastomeric synthetic polymers are preferred, such as are common in the dispenser art.

In an alternative structure to the hinged attachment of the second part, the second part can be attached and removed by screwing and unscrewing the second part from the first part.

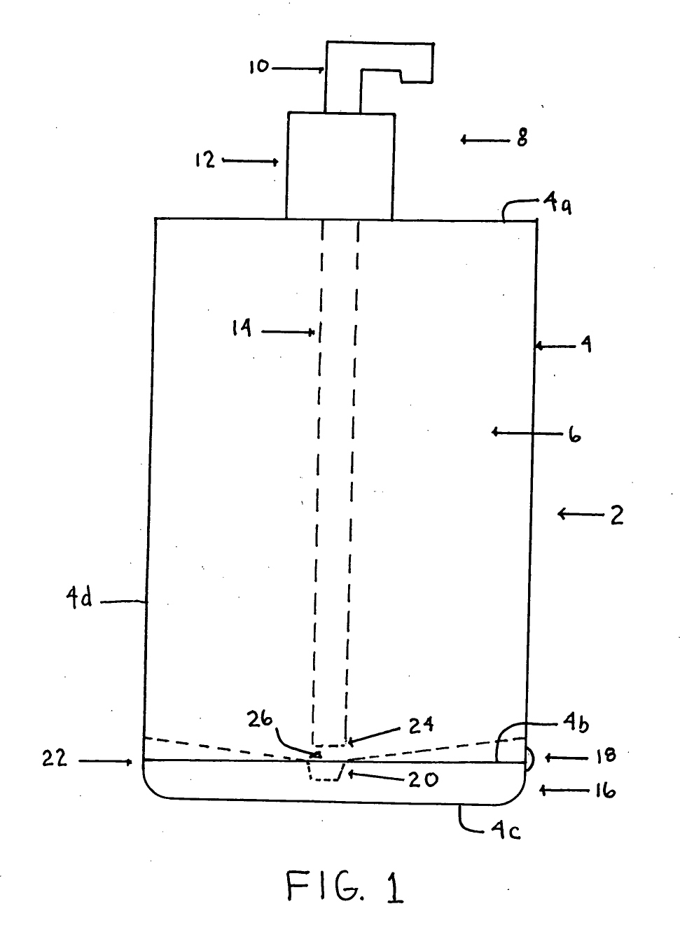

Reviewing and discussing the FIGURE will assist in an additional understanding of the practice and scope of the present invention. FIG. 1 shows a side view of a dispenser 2 according to the present technology. The dispenser 2 is shown in FIG. 1 with a structural body 4 which defines a volume 6 within which dispensable material can be stored. The structural body is shown with a top 4a and a two-part bottom 4b and 4c. The bottom 4b is the internal bottom within the volume 6 and the second portion of the bottom 4c is shown as a hinged element 16 that closes a spout 20 that extends out of the internal bottom 4b. The hinged element 16 forms a closure line 22 that closes off the hole 20 and prevents any flowable material from exiting the spout 20 until the hinged element 16 is swung away or detached from the closure line 22 and away from the spout 20. A living hinge 18 is shown, but as described herein, alternative physical connecting and detaching elements may be used to connect the second part 16 to the structural body 4. A side 4d is particularly identified in the FIGURE.

At the top 4a is shown a pump attachment system 8 comprising a connector 12 or cap, and a pump 10 is shown with its access tube 14 extending into the volume 6 with its lowermost extension and opening 24 positioned slightly above the interior bottom 4b. Although specific structures and materials have been described herein, those limiting descriptions are to be understood as examples of species within the generic concepts of the invention and not a limiting the scope of protection afforded by the attached claims.

The dispenser of the present invention may be used for many different commercial materials which include but are not limited to: lotions, hand soap, shampoo, conditioner, hand sanitizer, body wash, sun screen, facial cleanser, ketchup, mustard, liquid laundry detergent, oils, dispersions, emulsions, cologne, perfume and household cleaners. Once the pump can no longer force out the gel or liquid, yet the user realizes there is still material in the container, the bottom opening can be exposed, the container squeezed, and the additional material squeezed from the container. The bottom hole should not be so large in comparison to the viscosity of the material that it would pour from the container without any increase in internal pressure from the squeezing.

What is claimed:

1. A dispenser for flowable materials comprising:
a storage area having a top and a bottom and sides defining a volume within the dispenser;
the top of the dispenser having a manually useable pump attached thereto;
the pump having an access tube extending from the pump into the volume within the dispenser, the access tube passing from the top towards the bottom of the dispenser within the volume;
the bottom of the dispenser comprising two parts:
a first part comprising a surface within the volume capable of supporting the flowable materials within the volume and having a hole therein through which flowable material may flow; and
the second part of the bottom of the dispenser comprising a cap that is detachably connected to the first part and prevents flowable material through the hole when attached and allows flowable material to flow through the hole when unattached.

2. The dispenser of claim 1 wherein the second part comprises a hinged lid that swings to open and close the hole and remains attached to the dispenser while the hole is opened by the second part being unattached to the hole.

3. The dispenser of claim 2 wherein the hinged lid comprises a living hinge that has a snap attachment removeably connecting the second part to the first part.

4. The dispenser of claim 3 wherein the snap attachment directly engages a spout from the hole.

5. The dispenser of claim 1 wherein the surface of the first part slopes towards the hole within the volume.

6. The dispenser of claim 2 wherein the surface of the first part slopes towards the hole within the volume.

7. The dispenser of claim 3 wherein the surface of the first part slopes towards the hole within the volume.

8. The dispenser of claim 4 wherein the surface of the first part slopes towards the hole within the volume.

9. The dispenser of claim 1 wherein the sides comprise a flexible polymeric material such that when the sides are compressed, pressure is applied to flowable material to force flowable material out of the hole when the second part is unattached to the hole.

10. The dispenser of claim 2 wherein the sides comprise a flexible polymeric material such that when the sides are compressed, pressure is applied to flowable material to force flowable material out of the hole when the second part is unattached to the hole.

11. The dispenser of claim 3 wherein the sides comprise a flexible polymeric material such that when the sides are compressed, pressure is applied to flowable material to force flowable material out of the hole when the second part is unattached to the hole.

12. The dispenser of claim 4 wherein the sides comprise a flexible polymeric material such that when the sides are compressed, pressure is applied to flowable material to force flowable material out of the hole when the second part is unattached to the hole.

13. The dispenser of claim 5 wherein the sides comprise a flexible polymeric material such that when the sides are compressed, pressure is applied to flowable material to force flowable material out of the hole when the second part is unattached to the hole.

14. The dispenser of claim 6 wherein the sides comprise a flexible polymeric material such that when the sides are compressed, pressure is applied to flowable material to force flowable material out of the hole when the second part is unattached to the hole.

15. The dispenser of claim 7 wherein the sides comprise a flexible polymeric material such that when the sides are compressed, pressure is applied to flowable material to force flowable material out of the hole when the second part is unattached to the hole.

16. The dispenser of claim 8 wherein the sides comprise a flexible polymeric material such that when the sides are compressed, pressure is applied to flowable material to force flowable material out of the hole when the second part is unattached to the hole.

17. The dispenser of claim 1 wherein the second part can be attached and removed by screwing and unscrewing the second part from the first part.

18. The dispenser of claim 7 wherein the sides comprise a flexible polymeric material such that when the sides are compressed, pressure is applied to flowable material to force flowable material out of the hole when the second part is unattached to the hole.

19. A method for dispensing a liquid or gel from an enclosed container comprising:
a) providing a container with a top and a bottom;
b) providing the container with liquid or gel therein, the container having a pump on its top and source tube extending into the liquid or gel;
c) the container also having an exposable sealed opening on its bottom;
d) pressing a pump handle to provide gel or liquid to a user; and
e) exposing the opening on the bottom to provide gel or liquid to a user.

20. The method of claim 19 wherein step e) is performed after an insufficient volume of the gel or liquid is provided by pressing the pump handle.
